(19) United States
(12) Patent Application Publication
(10) Pub. No.: US 2006/0210053 A1
(43) Pub. Date: Sep. 21, 2006

(54) Switcher for networks and tradition telephones

(76) Inventor: Hsi-Fan Chang, Taipei (TW)

Correspondence Address: CHARLES E. BAXLEY, ESQ., 90 JOHN STREET, THIRD FLOOR, NEW YORK, NY, 10038, US

(21) Appl. No.: 11/122,483

(22) Filed: May 4, 2005

(30) Foreign Application Priority Data
Mar. 15, 2005 (CN) 2005200555410

(51) Int. Cl. H04M 3/00

(52) U.S. Cl. 379/332

(57) ABSTRACT

The present invention relates to a switcher of networks telephone and traditional telephone, which includes a sound A/D (Analog/Digital) converter with a computer connecting port that may be wire or wireless interface, said converter is connected to a switch that has a commutating circuit, and said commutating circuit connects with a speaker and a call-in alarm device, and a converter adapter, a traditional telephone port and a LAN or Ethernet port, and a handset port; by means of shifting networks telephone and traditional telephone, sharing a common microphone to send information facilitates to the consumers, meanwhile the consumers are able to handle efficiently the telephone peripheral devices, and saving consuming cost; the simplified structure and high practicality are the features of the present invention.

### BACKGROUND OF THE INVENTION

1. Field of the Invention

The present invention relates to a switcher for networks and tradition telephones, and more especially to a communication switching device, whereby a handset is shared whenever communicating by networks telephone or traditional telephone.

2. Description of Prior Art

Along with the development of electrical information industry, by means of wire or wireless transmission way, in-time receiving and sending information allows the users to apply rapid exchanging information method in processing public or private business, or common daily-life.

As it is known, using telecommunication telephone to receive and send information has been commonly used, wherever in office, or in home or other common sites, but along with the development of computer networks, the networks telephone is came out fortunately, depending on the much lower cost and popularly application of computer and networks, the networks telephone and the traditional telephone have to be used together in many offices or homes, so that there are individual two telephone sets—one has to be attached on a computer for calling in or out as a networks telephone, such as headphone integrated with a microphone, or microphone and speaker set, but one working as a traditional telephone need to be used for calling in or out on the conventional telephone line, therefore, wherever in offices or homes, as communicating, two individual telephone or speaker sets will occur to many telephone peripheral devices, so that the user is difficult to handle them efficiently, meanwhile the overmuch peripheral devices bring up unnecessary waste to increase the using cost to the consumers, and bring to inconveniently operate as using, so how to integrate networks telephone and traditional telephone into a whole set is became to a main tendency in the inside of industry.

### OBJECTS AND SUMMARY OF THE INVENTION

For overcoming the above said shortcomings of the prior art, it is therefore a main object of the present invention to provide a switcher of networks telephone and traditional telephone, by means of sharing a common handset as communicating by networks telephone or traditional telephone meeting convenient feather for operating, meanwhile allowing consumers efficiently handling the telephone peripheral devices, and decreasing consumption cost.

This object is achieved by the present invention, within said switcher of networks telephone and traditional telephone including a sound A/D (Analog/Digital) converter with a computer connecting port, the feature is that said converter connects to a switch that has a commutating circuit, and said commutating circuit connects with a speaker and a call-in alarm device, and a converter adapter, a traditional telephone line port and a LAN or Ethernet port, and a traditional telephone port and a handset port; said speaker is designed to remind the user as a networks phone call is coming in; said switch also has a hand-free device and microphone port so that the users have different choice of communicating depending on the different necessary; said alarm device can be a buzzer or a little lamp or both used for reminding a traditional phone call coming in.

In practice, said converter of the present invention is connected to computer with one end, and the another end is coupled to the converter adapter of the switch, and the LAN or Ethernet port of the switch is connected to the public net, meanwhile the tradition telephone line port is connected to the public telephone line too, the phone port is connected with a traditional telephone set, the handset port is plugged on with the handset of the phone set, by means of the switch, changing the communication way between networks telephone and traditional telephone carries out exchanging information; the vital point of the present invention is that the converter is connected to the switch, which is built in with commutating circuit throw-over networks telephone and traditional telephone, in order to share a common microphone to send information to facilitating the consumers, meanwhile the consumers are able to handle efficiently the telephone peripheral devices, and saving consuming cost; the simplified structure and high practicality are the features of the present invention.

### BRIEF DESCRIPTION OF THE DRAWINGS

FIG. 1 is an exploded view showing the disassembled state of the present invention.

FIG. 2 is a solid view showing the combined state of the present invention.

FIG. 3 is a scheme showing the circuit diagram of the present invention.

FIG. 4 is a solid view showing an embodiment of the present invention.

FIG. 5 is a scheme showing another embodiment of the present invention.

### DETAILED DESCRIPTION OF PREFERRED EMBODIMENTS

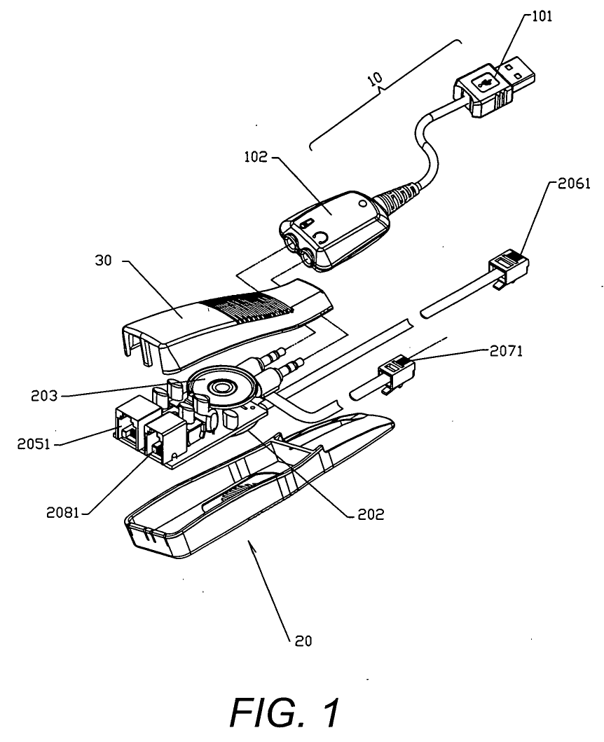

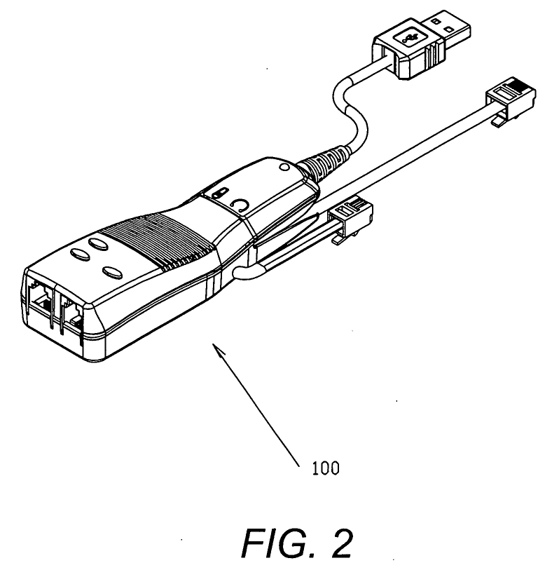

Referring to FIG. 1 to FIG. 4, the switcher of networks telephone and traditional telephone provided by the present invention is comprised of a sound A/D converter 10 with a computer port 101, and a switch 20 coupled to said converter 10, wherein said switch 20 includes a commutating circuit 201 connecting with a speaker 202 and a call-in alarm device 203, and a converter adapter 204, a handset port 208 and a LAN or Ethernet port 205, and a traditional telephone port 206 and 207; said speaker 202 is designed to remind the user as a networks phone call is coming in; said switch 20 also includes a hand-free device 209 and microphone port 210 so that the users have different choice of communicating way depending on the different necessary; said alarm device 203 can be a buzzer or a little lamp used for reminding a traditional phone call coming in. referring to FIG. 2, said switch 20 is covered with a set of shell 30, said each port or connectors or sockets should be matched with relative coordinated components.

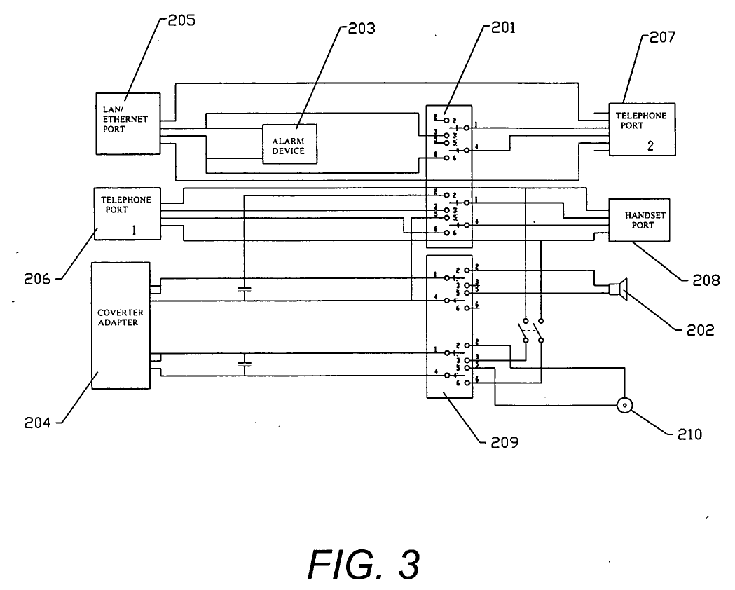

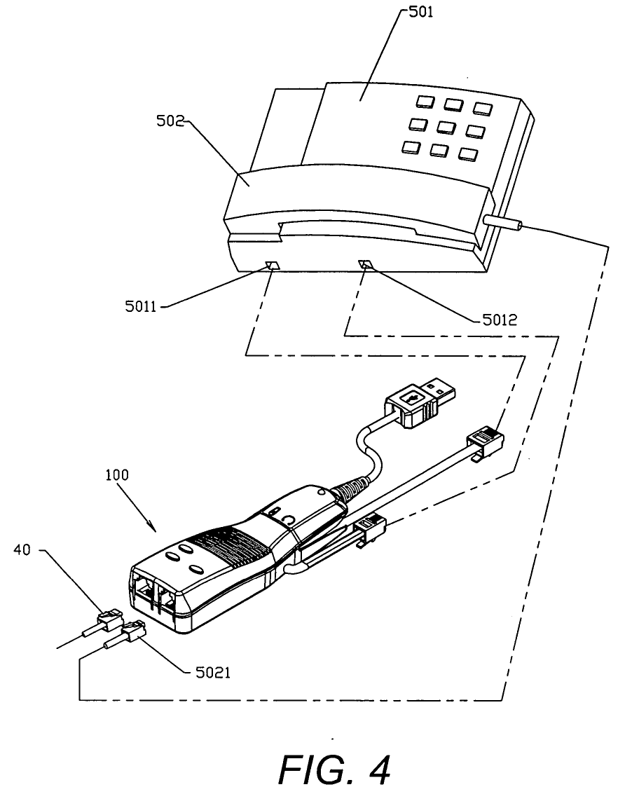

Referring to FIG. 4, said converter 10 of the present invention has a computer port 101 at one end for connecting with computer, said computer port 101 can be an USB port or other coordinated ports; and the another end is coupled to the converter adapter 204 of the switch 20, and a socket 2051 built upon the LAN or Ethernet port 205 of the switch 20 of the switch 20 is connected to the public net with an Ethernet plug 40, meanwhile the traditional telephone ports 206 and 207 of said switch 20 are respectively led out two coordinated plugs 2061 2071 for connecting to the sockets 5011 5012 built upon the traditional telephone 50, within one is designed to connect the handset 502 to the phone set 501, another is used to connect to public Ethernet; a socket 2081 built upon the handset port 208 is used to plug the plug 5021 of the handset 502 in; as shown in FIG. 3, when a traditional phone call or a networks phone call is coming in, by means of the switches SW1 SW2, changing the communication way between networks telephone and traditional telephone carries out exchanging information; the vital point of the present invention is that the converter is connected to the switch, which is built in with commutating circuit throw-over networks telephone and traditional telephone, in order to share a common microphone to send information to facilitating the consumers, meanwhile the consumers are able to handle efficiently the telephone peripheral devices, and saving consuming cost; the simplified structure and high practicality are the features of the present invention.

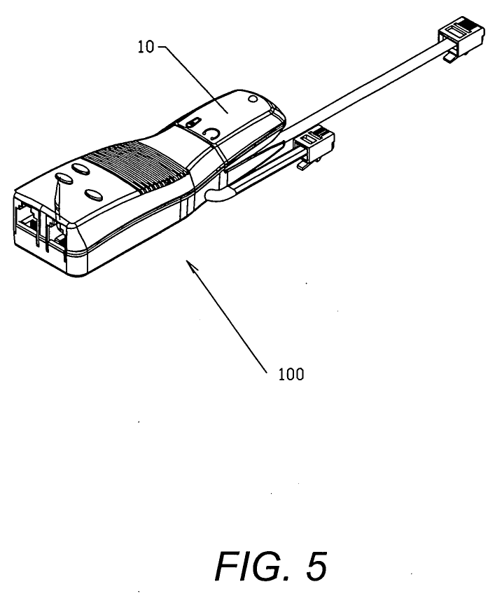

Above description just shows an embodiment of the present invention, as shown in FIG. 5, another embodiment is presented, in which said converter 10 can be also in wireless connection to computer, such as embedded a Bluetooth system at inside or other wireless communication system.

I claim:

1. A switcher of networks telephone and traditional telephone including a sound A/D (Analog/Digital) converter with a computer connecting port, the said converter connects to a switch that has a commutating circuit, and said commutating circuit connects with a speaker and a call-in alarm device, and a converter adapter, a traditional telephone port and a LAN or Ethernet port, and a handset port.

2. A switcher of networks telephone and traditional telephone as claimed in claim 1, wherein said switch is attached with a hand-free device.

3. A switcher of networks telephone and traditional telephone as claimed in claim 1, wherein said switch is built upon with a microphone port.

4. A switcher of networks telephone and traditional telephone as claimed in claim 1, wherein said alarm device can be a buzzer or a little lamp.
